(19) United States
(12) Patent Application Publication
(10) Pub. No.: US 2003/0177141 A1
(43) Pub. Date: Sep. 18, 2003

(54) Customer queue management method and device therefore

(76) Inventor: Marcus Sahlin, Onsala (SE)

Correspondence Address: BIRCH STEWART KOLASCH & BIRCH, PO BOX 747, FALLS CHURCH, VA, 22040-0747, US

(21) Appl. No.: 10/311,266

(22) PCT Filed: Jun. 11, 2001
(86) PCT No.: PCT/SE01/01185

(30) Foreign Application Priority Data
Jul. 6, 2000 (SE) 0002251-7

(51) Int. Cl. G06F 7/00

(52) U.S. Cl. 707/104.1

(57) ABSTRACT

A method of providing one or more service types to customers at least one work station in an orderly fashion by means of a queue management system. According to the invention customers are biometrically scanned to thereby establish a matching or not in a database which comprises information on customers. If there is a match in the database, the information in the database can forward at least an identity to an appropriate work station when a customer in question is summoned to that work station. It is also possible to connect a biometric scan that does not match any entries in the database with a person that does business at a work station where the person in question identifies herself or is identified, and thus make an entry in the database.

### FIELD OF THE INVENTION

The present invention relates generally to a method and a device for serving customers in at least one queue sequence for one or more service types at one or more service points or so called work stations.

### BACKGROUND TO THE INVENTION

Queue sequencing customers by means of dispensing queue numbers to the customers is described, for example, in U.S. Pat. No. 4,675,647. The described system allows customers to choose a specific desired service point. Attempts have been made to refine queue sequencing systems, such as the one according to the referred patent, in order to provide an even better actual service or at least a better perceived service to the customers. One such system is described in the PCT-application WO 97/03418 which allows a customer to enter an individual code into a central unit to obtain a priority over other customers. However, it could be considered a disadvantage that it is apparent to other customers that some customers are more privileged than others are. There is thus a need to improve queue-sequencing systems to thereby offer an improved privacy and/or priority to privileged customers, both as to the visibility of their privilege, as to their inconvenience of entering the individual code.

### SUMMARY OF THE INVENTION

An object of the invention is to define a method of and a device for queue management.

Another object of the invention is to define a method for and a device for providing privacy to privileged customers as to their privilege in a queue management system.

A further object of the invention is to define a method and a device of enabling a passive automatic identification of customers in a queue management system.

Still a further object of the invention is to define a method and a device of identifying a customer in a queue management system without the need of any action of the customer.

The aforementioned objects are achieved according to the invention by a method of providing one or more service types to customers at at least one work station in an orderly fashion by means of a queue management system. A work station, a service position, can for example be a cashiers desk or an office (e.g. of a doctor or a lawyer). According to the invention customers are biometrically scanned to thereby establish a matching or not in a database which comprises information on customers, such as if the customer is a privileged customer, to which it is desirable to give priority, or not. If there is a match in the database, the information in the database can be used for prioritizing customers, give personalized options, and also forward information concerning the customer in question such as the customer's identity, to an appropriate service position when a customer in question is summoned to that service position. Information concerning a customer can, for example, be a photograph or a signature apart from the customer's name and possible associated information such as account details, previous prescriptions or a medical journal. To enable a dynamic updating of the database, it is also possible to logically connect a biometric scan that does not match any entries in the database with a person that desires service. The connection is preferably performed at a work station where the customer receives the desired service. The person in question will preferably either be recognized or somehow identified at the workstation in question. The database will then comprise one more connection between a person and a biometric scan, which connection can be used the next time the person enters an establishment which uses the database. To be noted is that the database with the biometric identities can in some embodiments be a remote database that only comprises unique personal identities, such as social security numbers or personal numbers, which are coupled to biometric identities. A request to a database will consist of a biometric identity and in return a unique personal identity or a no match response will be received. Any further information concerning an identified person will, if necessary, be retrieved from local databases using the unique personal identity.

The aforementioned objects are also achieved according to the invention by a method of servicing customers with one or more service types at at least one work station. According to the invention the method comprises a number of steps. In a first step a customer is biometrically scanned at a selection unit. In a second step a biometric identity is generated from the biometric scan. In a third step a database comprising biometric identities associated with customer data is searched. In a fourth step it is determined if there is a match or not of the generated biometric identity with a biometric identity of the database. In a fifth step the customer is provided with a choice of one or more service types at a selection unit. A service type can, for example, be cash withdrawal, throat complaints, or a specific staff member such as your own personal bank advisor, i.e. a service type can either be a service itself or a person which will then give a service, a service giving person. In a sixth step queue information for a selected service type is dispensed/supplied upon a customer selection in dependence of one or more factors. In a seventh step, if there is a determined match of the generated biometric identity with a biometric identity of the database, then at least a part of the customer data associated to the determined matched biometric identity of the database is transferred to the work station that the customer is directed to. Thus enabling a passive automatic identification of customers.

In one version of the method, the step of scanning a customer biometrically, comprises the substep of performing an optical scan generating picture information, which is used for face recognition. In other versions of the method, the step of scanning a customer biometrically, comprises the substep of performing a fingerprint scan. And in still other versions of the method the step of scanning a customer biometrically, comprises the substep of performing an optical eye scan. In some versions of the method the step of scanning a customer biometrically, comprises the substep of performing a signature scan

In some versions of the method the step of providing the customer with a choice of one or more service types at the selection unit, is done based on the results of the step of determining a match or not of the generated biometric identity with a biometric identity of the database. Then preferably if it is determined no match then a default choice of one or more service types, such as general practitioner or a heart specialist, is provided to the customer. Advantageously also if it is determined a match then the choice of one or more service types, such as the customer's house doctor or a specific staff member, provided to the customer is in dependence of one or more parameters of the customer. Preferably one of the one or more parameters is if the customer has an appointment or not. Advantageously one of the one or more parameters is a determined importance of the customer.

In some versions of the method one of the factors the step of dispensing/supplying queue information for a selected service type upon a customer selection is done in dependence of, is the results of the step of determining a match or not of the generated biometric identity with a biometric identity of the database. Preferably if it is determined no match then the queue information supplied is a queue number which is based on a normal priority to the selected service type. Advantageously also if it is determined a match then the queue information supplied is in dependence of the selected service type and/or one or more parameters of the customer. Preferably one of the one or more parameters is a determined importance of the customer. Customers which are given priority are preferably put in a special queue sequence, i.e. a speparate number series.

In some versions of the method, the method further comprises the step of establishing an entry in the database with the generated biometric identity and associated customer data, if in the step of determining a match or not, it is determined that there is no match between the generated biometric identity with a biometric identity of the database. The database is then fed with the generated biometric identity and a customer identification.

In some versions of the method, the method further comprises the step of directing the customer to a work station/service position according to the selected service type.

One or more of the features of the above-described different methods according to the invention can be combined in any desired manner, as long as the features are not contradictory. The aforementioned objects are achieved in accordance with the invention also by a queue management system which enables servicing of customers with one or more service types at at least one work station/service position. The system comprises a plurality of means. A first means arranged to scan a customer biometrically at a selection unit. A second means arranged to generate a biometric identity from the biometric scan. A third means arranged to search a database comprising biometric identities associated with customer data. A fourth means arranged to determine a match or not of the generated biometric identity with a biometric identity of the database. A fifth means arranged to provide the customer with a choice of one or more service types at a selection unit. A sixth means arranged to dispense/supply queue information for a selected service type upon a customer selection in dependence of one or more factors. A seventh means arranged to transfer, if there is a determined match of the generated biometric identity with a biometric identity of the database, at least a part of the customer data associated to the determined matched biometric identity of the database to the service position that the customer is directed to. According to the invention the system can thus enable a passive automatic identification of customers.

Different embodiments of the device according to the invention can be reached according to additional features mentioned above in connection with the description of the method according to the invention. The features of the above-described different embodiments of a device according to the invention can be combined in any desired manner, as long as no conflict occurs.

By providing a method for queue management and by providing a queue management system according to the invention several advantages over prior art systems are attained. It is not made obvious that certain customers are privileged and given special treatment such as a priority over other customers, privileged customers can keep their privacy as to their status. Customers, privileged or not, do not have to remember any codes or have any special card. It is usually not desirable for a customer to have to take out a card and/or openly use a code which can be seen by other persons, this action might additionally display other things that are in the customer's possession which in turn might create a risk of, for example, being robbed. There is thus no need for privacy screens, placement of a selection unit at an obscure remote location or any other elaborate measures to ensure the privacy of the customers. Other advantages with a management system according to the invention are that there is no need for a customer to preregister, this can be accomplished completely automatically by the system itself. Unregistered customers are scanned and a biometric identity is created based on the scan. When an unregistered customer is called to a work station, the customer in question will most likely identify him- or herself, thus making it possible to create a link in a database between the identity of the customer and the created biometric identity. Thereafter, based on the knowledge of the true identity of the customer, special privileges, such as prioritizing the customer, can be accorded to the customer in question based on, for example, assets in a bank. This feature of the invention can also help prevent fraud If a person whose biometric identity does not generate a match in the database tries to identify him- or herself as someone who exists in the database, then there is a discrepancy of biometric identities and an alarm can be made. An alarm can also be made if the biometrically scanned person at the selection unit is not the same as the person who arrives at the work station. A photograph of a person at the selection unit can be forwarded to the work station, as well as stored in the database. A history of pictures can then be presented at the work station, either to prevent fraud or to just add a personal touch to the visit by enabling the person at the work station to comment that, for example, that the customer has changed hairstyle. Further, based on a match with a registered customer, a customized menu can be provided at a selection unit. In a bank, for example, a customer/client in question has made an appointment with an advisor but desires to make a cash withdrawal first. A customized menu can then be provided with, for example, a first choice of going directly to the advisor and a second choice of attending other bank business first. Then if the customer chooses to attend other bank business first, then a prioritized customer can be put first in a special queue, and then when the business is concluded or almost concluded at the service point then the advisor can be alerted that his customer is ready for him/her. Preferably the advisor was immediately alerted that his/her client had arrived the minute he or she was identified, and also communicated that the client desired to make other business first. A queue management system according to the invention can also alert an interested party, such as a person responsible for an important customer/client in question, at a place of business to make the party aware of the presence of a very important customer within the premises. The queue management system according to the invention can be used in many different places of business, such as hospitals, pharmacies, banks, insurance companies, social support officies, unemployment offices, police stations, embassies, etc. The queue management system according to the invention provides many advantages, more of which will become apparent from the following description.

### DESCRIPTION OF THE FIGURES

The invention will now be described in more detail for explanatory, and in no sense limiting, purposes, with reference to the following figures, in which

FIG. 1 shows a typical application of the invention,

FIG. 2 shows a block diagram of an implementation of the invention,

FIG. 3 shows a flow chart of a basic method to obtain a queue number/information according to the invention,

FIG. 4 a flow chart of a first specific method to obtain a queue number/information according to the invention,

FIG. 5 a flow chart of a second specific method to obtain a queue number/information according to the invention.

### DESCRIPTION OF PREFERRED EMBODIMENTS

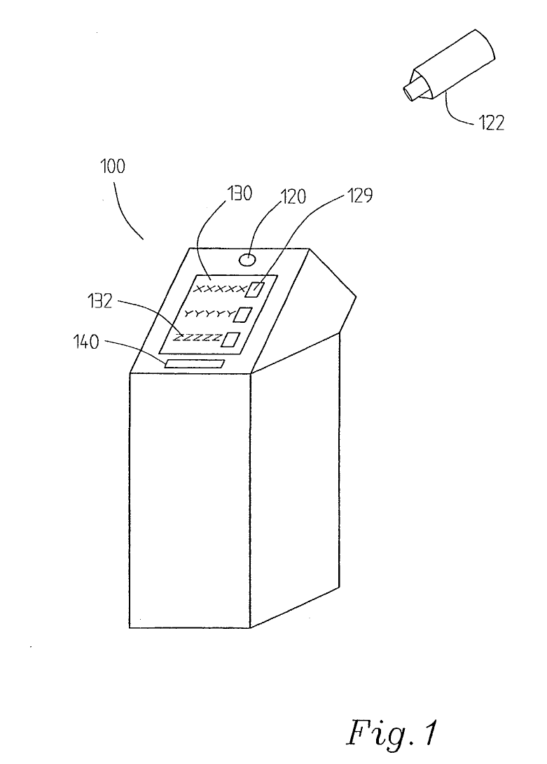

In order to clarify the system according to the invention, some examples of its use will now be described in connection with FIGS. 1 to 5.

FIG. 1 shows a typical application of the invention. A selection unit 100 is placed in a desirable place in a place of business, such as in a bank. A queue management system according to the invention has at least one biometric sensor 120, 122, 129 for scanning biometrics. Shown in FIG. 1 are three examples of placement and functioning of a biometric sensor, however, it is to be understood that the invention is not restricted to what type of biometric sensor used nor its placement. A first optical biometric scanning unit 120 is placed in the selection unit 100. In some embodiments according to the invention it is conceivable that this biometric sensor 120 is a biometric finger print scanning unit, a customer would then be instructed to place his or her finger on the sensor 120. A second optical biometric scanning unit 122 can for example share its duties with a conventional security camera. This can be advantageous both as to an economical side as to a discrete manner of extending the capabilities of an existing queue management system with a queue management system according to the invention. A third alternative is to use user selection buttons 129 either static buttons, dynamic buttons or a touch screen with biometric scanning capabilities, preferably a finger print scanner. The user selection buttons 129 will belong to a user interface 130, which also preferably includes a display 132 of selection choices. The display 132 can be either static or dynamic. Finally, when a customer/client has made a choice, then the customer is informed of his or her queue position, preferably by means of a queue number on a queue ticket provided to the customer by means of a dispensing unit.140. A customer is alerted when it is his or her turn by a display (not shown) showing what queue number is up and which service position/work station is free (if there are more than one work station). In some versions of the queue management system according to the invention, under certain conditions, a queue number is not given, preferably a ticket can be given anyway as not to arouse any suspicion of anything out of the ordinary happening. These conditions can, for example, be when a customer has a timed (or not) appointment with someone at the place of business (or a privileged customer that is given an additional choice of asking to see someone) and is not interested in doing any additional business at a service position. A ticket in question can then inform the customer that the person in question has been alerted and that he or she will soon be able to receive the customer, or inform the customer to please go and see the desired person. The possibilities with a queue management system according to the invention are enormous.

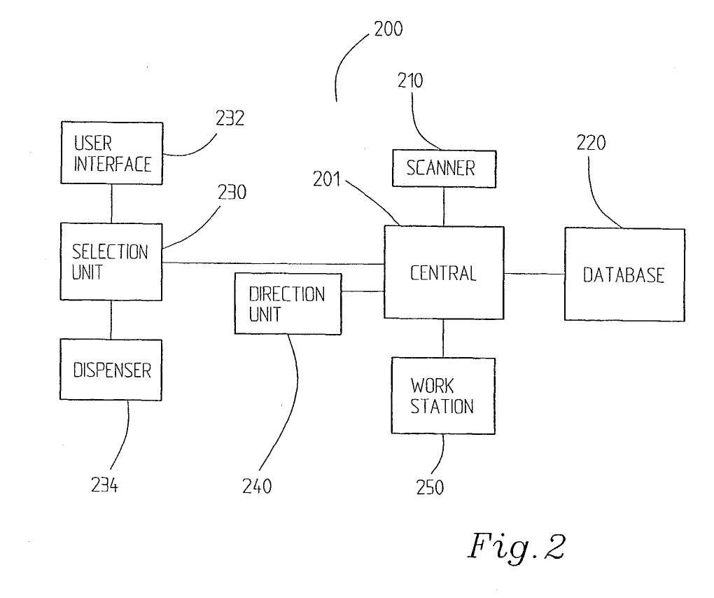

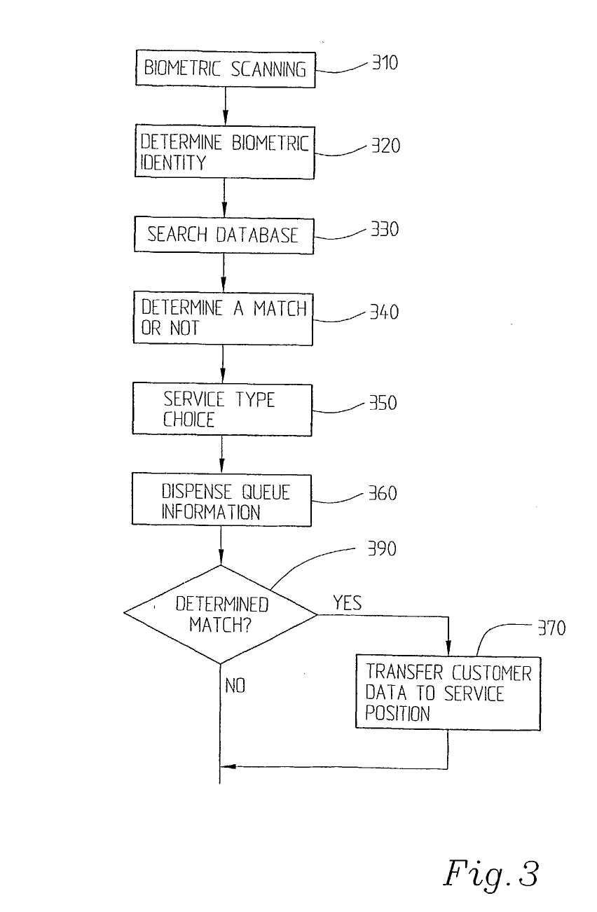

FIG. 2 shows a block diagram of a preferred implementation of a queue management system 200 according to the invention. A queue management system 200 according to the invention will preferably comprise a central processing unit 201, a biometric scanner 210, a biometric identity database 220. The queue management system 200 will additionally also either comprise or simply be connected to a selection unit 230, a direction unit display 240, and one or more service positions/work stations 250 to where customers are directed. It is to be noted that a work station can also be a person. The selection unit 230 will preferably comprise a user interface 232 with at least an input means for selection and possibly also static or dynamic display control of selection choices, and comprise a dispenser 234 for turn or queue numbers. The central processing unit 201 directs and controls the flow of information between different units. The biometric scanner 210 will provide the central processing unit 201 with a biometric scan. The central processing unit 201 will convert the biometric scan to a biometric identity, if the biometric scanner 210 has not already done this directly. The central processing unit 201 will then query the biometric database 220.to see if there exists an entry for the biometric identity. Then, in dependence on if there is a match or not and in dependence of a specific implementation, the central processing unit 201 will control and direct the user interface 232, the dispenser 234, the direction unit 240 and eventually provide an appropriate work station 250 with appropriate information. In some implementation the central processing unit 201 will get feedback from a work station about, for example, the identity of a customer that can be used for updating the biometric database 220. A discussion about different possibilities of a queue management system according to the invention will be provided in connection with FIGS. 3 to 5.

FIG. 3 shows a flow chart of a basic method to obtain a queue number/information according to the invention. The basic method is described in seven steps and a router. In a first step 310 a customer is biometrically scanned. As described previously, the biometric scanning can take on many different forms. From the first step 310, a second step 320 follows, which determines a biometric identity from the biometric scan. From the second step 320 a third step 330 follows, which searches a database of biometric identities for a match of the determined biometric identity. From the third step 330, a fourth step 340 follows, which determines if there is a match of the determined biometric identity with the biometric identities of the database. To be mentioned is that this and the other flow charts in this description are described as sequential processes, however many parts of the methods can be performed in parallel as independent processes which only converge at certain points. A fifth step 350 receives input from a customer as to a desired service type choice. From the fifth step 350, a sixth step 360 follows, which dispenses queue or other information to a customer. From the sixth step 360, a router 390, which routes the method/procedure to a redirected seventh step 370 if there is determined a match in the fourth step 340, otherwise the method/procedure just continues to some other processing or goes directly to the first step 310. From the router 390, the redirected seventh step 370, which either directly or in combination when a determination of when the customer in question is or is to be called to a position of a desired service, transfers customer data to an appropriate work station.

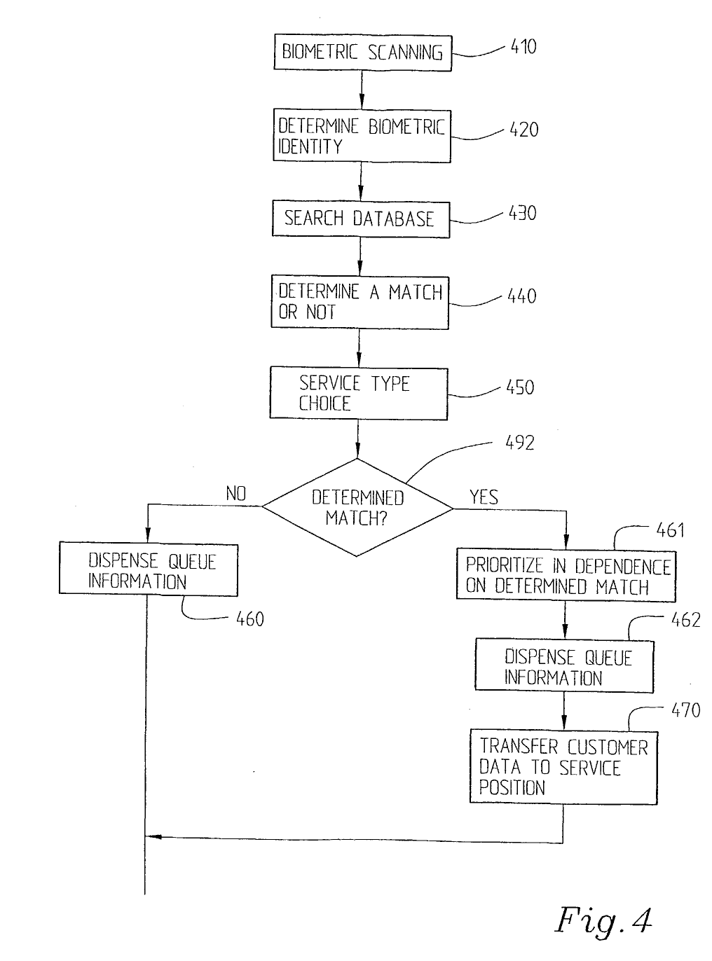

FIG. 4 shows a flow chart of one method to obtain a queue number/information according to the invention. The first five steps 410, 420, 430, 440, 450 are identical or at least substantially similar to the first five steps 310, 320, 330, 340, 350 described in relation the basic method of the invention of FIG. 3 and will therefore not be repeated here. From the fifth step 450, follows a router 492, which routes the method/procedure to a sixth step 460 if there is no determined match in the fourth step 440, and if there is determined a match in the fourth step 440 then the method/procedure is routed to a redirected first sixth step 461, From the router 492, the sixth step 460 follows as one of the possibilities. The sixth step 460 dispenses queue information to a customer. From the router 492, a redirected first sixth step 461 follows as another possibility. The redirected first sixth step 461 prioritizes the customer in dependence on the determined match. From the redirected first sixth step 461, follows a redirected second sixth step 462, which dispenses queue information to a customer. From the redirected second sixth step 462, follows a redirected seventh step 470, which, either directly or in combination when a determination of when the customer in question is or is to be called to a position of a desired service, transfers customer data to an appropriate work station.

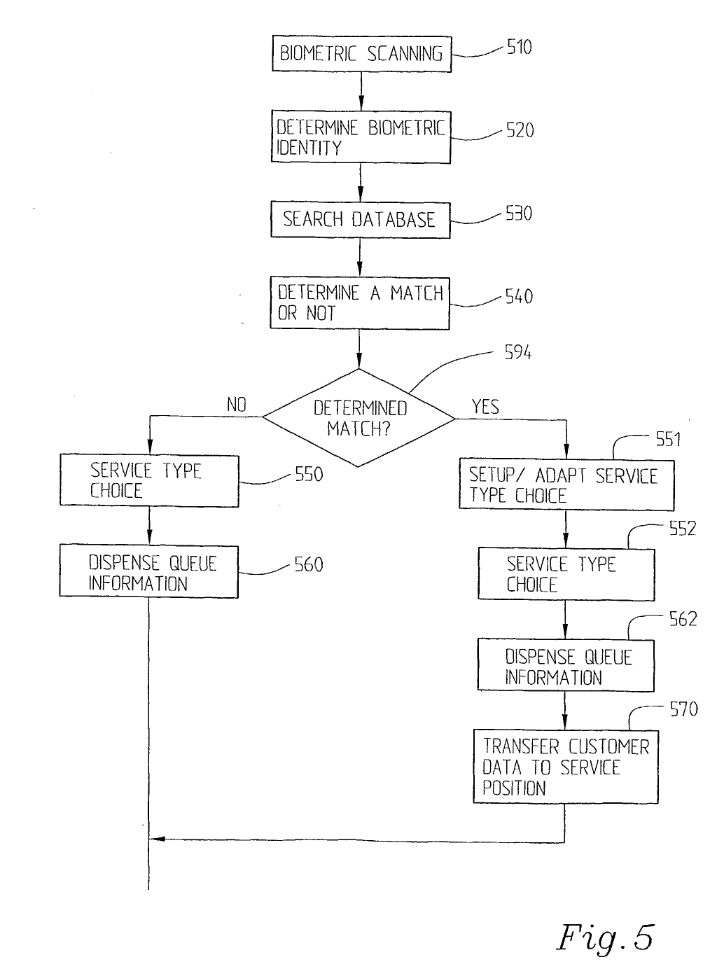

FIG. 5 shows a flow chart of another method to obtain a queue number/information according to the invention. The first four steps 510, 520, 530, 540 are identical or at least substantially similar to the first four steps 310, 320, 330, 340 described in relation the basic method of the invention of FIG. 3 and will therefore not be repeated here. From the fourth step 540, follows a router 594, which routes the method/procedure to a fifth step 550 if there is no determined match in the fourth step 540, and if there is determined a match in the fourth step 540 then the method/procedure is routed to a redirected first sixth step 561. From the router 594, follows a fifth step 550 as one possibly route. The fifth step receives a customer service type choice. From the fifth step 550, follows a sixth step 560, which dispenses queue information to a customer. From the router 594, follows a redirected first fifth step 551 as another possible route. The redirected first fifth step 551 setups and possibly adapts the selectable service types to include more choices for prioritized customers, all in view of the determined match. From the redirected first fifth step 551, follows a redirected second fifth step 552, which receives a customer service type choice. From the redirected second fifth step 552, follows a redirected first sixth step 562, which dispenses queue information to a customer. From the redirected first sixth step 562, follows a redirected seventh step 570, which, either directly or in combination when a determination of when the customer in question is or is to be called to a position of a desired service, transfers customer data to an appropriate work station.

The present invention can be put into apparatus-form either as pure hardware, as pure software or as a combination of hardware and software. If the method according to the invention is realized in the form of software, it can be completely independent or it can be one part of a larger program. The software can suitably be located in a general-purpose computer or in a dedicated computer.

As a summary, the invention can basically be described as a device and a method which provide means to enable an efficient queue management, which is able to discretely prioritize chosen customers/clients without any involvement of the customer.

The invention is not limited to the embodiments described above but may be varied within the scope of the appended patent claims.

FIG. 1 shows a typical application of the invention,

100 a selection unit,

120 a first optical biometric scanning unit,

122 a second optical biometric scanning unit,

129 user selection buttons either static buttons, dynamic buttons or a touch screen with or without biometric scanning,

130 user interface,

132 display of selection choices, either static or dynamic,

140 dispensing unit.

FIG. 2A block diagram of an implementation of the invention,

200 queue management system according to the invention,

201 central processing unit,

210 biometric scanner,

220 biometric identity database,

230 selection unit,

232 user interface, at least input means for selection, possibly also static or dynamic display control of selection choices,

234 dispenser for turn number,

240 direction unit, display,

250 one or more service positions/work stations to where customers are directed.

FIG. 3 a flow chart of a basic method to obtain a queue number/information according to the invention,

310 a first step of biometrically scanning a customer,

320 from the first step 310: a second step of determining a biometric identity from the biometric scan,

330 from the second step 320: a third step of searching a database of biometric identities,

340 from the third step 330: a fourth step, which determines if there is a match of the determined biometric identity with the biometric identities of the database,

350 a fifth step receives a customer service type choice,

360 from the fifth step 350: a sixth step, which dispenses queue information to a customer,

390 from the sixth step 360: a router which routes the method/procedure to a redirected seventh step 370 if there is determined a match in the fourth step 340, otherwise the method/procedure just continues,

370 from the router 390: the redirected seventh step which, either directly or in combination when a determination of when the customer in question is or is to be called to a position of a desired service, transfers customer data to an appropriate work station.

FIG. 4 a flow chart of one method to obtain a queue number/information according to the invention,

410 a first step of biometrically scanning a customer,

420 from the first step 410: a second step of determining a biometric identity from the biometric scan,

430 from the second step 420: a third step of searching a database of biometric identities,

440 from the third step 430: a fourth step, which determines if there is a match of the determined biometric identity with the biometric identities of the database,

450 a fifth step receives a customer service type choice,

492 from the fifth step 450: a router which routes the method/procedure to a sixth step 460 if there is no determined match in the fourth step 440, if there is determined a match in the fourth step 440 then the method/procedure continues with a redirected first sixth step 461,

460 from the router 492: the sixth step, which dispenses queue information to a customer,

461 from the router 492: a redirected first sixth step, which prioritizes the customer in dependence on the determined match,

462 from the redirected first sixth step 461: a redirected second sixth step, which dispenses queue information to a customer,

470 from the redirected second sixth step 462: a redirected seventh step which, either directly or in combination when a determination of when the customer in question is or is to be called to a position of a desired service, transfers customer data to an appropriate work station.

FIG. 5 a flow chart of one method to obtain a queue number/information according to the invention,

510 a first step of biometrically scanning a customer,

520 from the first step 510: a second step of determining a biometric identity from the biometric scan,

530 from the second step 520: a third step of searching a database of biometric identities,

540 from the third step 530: a fourth step, which determines if there is a match of the determined biometric identity with the biometric identities of the database,

594 from the fourth step 540: a router which routes the method/procedure to a fifth step 550 if there is no determined match in the fourth step 540, if there is determined a match in the fourth step 540 then the method/procedure continues with a redirected first sixth step 561,

550 from the router 594: a fifth step receives a customer service type choice,

560 from the fifth step 550: the sixth step, which dispenses queue information to a customer,

551 from the router 594: a redirected first fifth step which setups and possibly adapts the selectable service types to include more choices for prioritized customers, in view of the determined match,

552 from the redirected first fifth step 551: a redirected second fifth step, which receives a customer service type choice,

562 from the redirected second fifth step 552: a redirected first sixth step, which dispenses queue information to a customer,

570 from the redirected first sixth step 562: a redirected seventh step which, either directly or in combination when a determination of when the customer in question is or is to be called to a position of a desired service, transfers customer data to an appropriate work station.

1. A method of servicing customers with one or more service types at at least one work station, characterized in that the method comprises the following steps:
scanning a customer biometrically at a selection unit;
generating a biometric identity from the biometric scan;
searching a database comprising biometric identities associated with customer data;
determining a match or not of the generated biometric identity with a biometric identity of the database;
providing the customer with a choice of one or more service types at a selection unit;
dispensing/supplying queue information for a selected service type upon a customer selection in dependence of one or more factors;
if there is a determined match of the generated biometric identity with a biometric identity of the database, then transferring at least a part of the customer data associated to the determined matched biometric identity of the database to the service position that the customer is directed to;
thus enabling a passive automatic identification of customers.

2. The method according to claim 1, characterized in that the step of scanning a customer biometrically, comprises the substep of:
performing an optical scan generating picture information, which is used for face recognition.

3. The method according to claim 1, characterized in that the step of scanning a customer biometrically, comprises the substep of:
performing a fingerprint scan.

4. The method according to claim 1, characterized in that the step of scanning a customer biometrically, comprises the substep of:
performing an optical eye scan.

5. The method according to any one of claims 1 to 4, characterized in that the step of providing the customer with a choice of one or more service types at the selection unit is done based on the results of the step of determining a match or not of the generated biometric identity with a biometric identity of the database.

6. The method according to claim 5, characterized in that if it is determined no match then a default choice of one or more service type is provided to the customer.

7. The method according to claim 5 or 6, characterized in that if it is determined a match then the choice of one or more service type provided to the customer is in dependence of one or more parameters of the customer.

8. The method according to claim 7, characterized in that one of the one or more parameters is if the customer has an appointment or not.

9. The method according to claim 7 or 8, characterized in that one of the one or more parameters is a determined importance of the customer.

10. The method according to any one of claims 1 to 9, characterized in that one of the factors the step of dispensing/supplying queue information for a selected service type upon a customer selection is done in dependence of, is the results of the step of determining a match or not of the generated biometric identity with a biometric identity of the database.

11. The method according to claim 10, characterized in that if it is determined no match then the queue information supplied is a queue number which is based on a normal priority to the selected service type.

12. The method according to claim 10 or 11, characterized in that if it is determined a match then the queue information supplied is in dependence of the selected service type and/or one or more parameters of the customer.

13. The method according to claim 12, characterized in that one of the one or more parameters is a determined importance of the customer.

14. The method according to any one of claims 1 to 13, characterized in that the method further comprises the step of:
establishing an entry in the database with the generated biometric identity and associated customer data, if in the step of determining a match or not, it is determined that there is no match between the generated biometric identity with a biometric identity of the database.

15. The method according to any one of claims 1 to 14, characterized in that the method further comprises the step of:
directing the customer to a work station according to the selected service type.

16. A queue management system which enables servicing of customers with one or more service types at at least one work station, characterized in that the system comprises:
means arranged to scan a customer biometrically at a selection unit;
means arranged to generate a biometric identity from the biometric scan;
means arranged to search a database comprising biometric identities associated with customer data;
means arranged to determine a match or not of the generated biometric identity with a biometric identity of the database;
means arranged to provide the customer with a choice of one or more service types at a selection unit;
means arranged to dispense/supply queue information for a selected service type upon a customer selection in dependence of one or more factors;
means arranged to transfer, if there is a determined match of the generated biometric identity with a biometric identity of the database, at least a part of the customer data associated to the determined matched biometric identity of the database to the work station that the customer is directed to;
thus enabling a passive automatic identification of customers.

17. The system according to claim 16, characterized in that the means arranged to scan a customer biometrically, is arranged to perform an optical scan generating picture information, which is used for face recognition.

18. The system according to claim 16, characterized in that the means arranged to scan a customer biometrically, is arranged to perform a fingerprint scan.

19. The system according to claim 16, characterized in that the means arranged to scan a customer biometrically, is arranged to perform an optical eye scan.

20. The system according to any one of claims 16 to 19, characterized in that the means arranged to provide the customer with a choice of one or more service types at the selection unit, is arranged to provide a choice based on if there is a determined match or not by the means arranged to determine a match or not of the generated biometric identity with a biometric identity of the database.

21. The system according to claim 20, characterized in that if it is determined no match then a default choice of one or more service type is provided to the customer.

22. The system according to claim 20 or 21, characterized in that if it is determined a match then the choice of one or more service type provided to the customer is in dependence of one or more parameters of the customer.

23. The system according to claim 22, characterized in that one of the one or more parameters is if the customer has an appointment or not.

24. The system according to claim 22 or 23, characterized in that one of the one or more parameters is a determined importance of the customer.

25. The system according to any one of claims 16 to 24, characterized in that at least one of the factors of the means arranged to dispense/supply queue information for a selected service type upon a customer selection in dependence of one or more factors, is based on if there is a determined match or not by the means arranged to determine a match or not of the generated biometric identity with a biometric identity of the database.

26. The system according to claim 25, characterized in that if it is determined no match then the queue information supplied is a queue number which is based on a normal priority to the selected service type.

27. The system according to claim 25 or 26, characterized in that if it is determined a match then the queue information supplied is in dependence of the selected service type and/or one or more parameters of the customer.

28. The system according to claim 27, characterized in that one of the one or more parameters is a determined importance of the customer.

29. The system according to any one of claims 16 to 28, characterized in that the system further comprises means arranged to establish an entry in the database with the generated biometric identity and associated customer data, if in the means arranged to determine a match or not, it is determined that there is no match between the generated biometric identity with a biometric identity of the database.

30. The system according to any one of claims 16 to 29, characterized in that the system further comprises means arranged to direct the customer to a work station according to the selected service type.
